(19) United States
(12) Patent Application Publication
(10) Pub. No.: US 2012/0180218 A1
(43) Pub. Date: Jul. 19, 2012

(54) STRETCHER USABLE AS A LIFE RAFT

(75) Inventors: Diederik Willem AUGUSTIJN, Den Haag (NL); Anke KEMPEN, Delft (NL); Jacobus Aaltjo RUIBING, Maarssen (NL); Robertus Johannes BARNHOORN, Breda (NL); Michael Petrus van SCHIE, Rijswijk (NL); Ernst Wichert Christiaan PUT, Delft (NL); Ivan TANIS, Delft (NL)

(73) Assignee: HONOR TECHNIEK B.V., Almere (NL)

(21) Appl. No.: 13/350,382

(22) Filed: Jan. 13, 2012

(30) Foreign Application Priority Data
Jan. 14, 2011 (NL) 1038523

(51) Int. Cl. A61G 1/00; A61G 1/007; B63C 9/04

(52) U.S. Cl. 5/626

(57) ABSTRACT

A stretcher is usable as a life raft. The stretcher is provided with an elongate support panel having a U-shaped inflatable tube, which surrounds the support panel on its front and sides. The inflatable tube has a first part, which is attached to the support panel and an adjoining second part, which forms an obtuse angle with the first part. The transition between the first part and second part forms a tilting point for the life raft in order to be able to tilt the life raft in the water between a first position in which the first parts of the inflated tube act as floats and a second position in which the second parts of the inflatable tube act as floats. By stowing away the deaerated inflatable tube in the support panel, the life raft can also be used as a stretcher for rescue operations on ice.

### BACKGROUND OF THE INVENTION

1. Field of the Invention

The invention relates to a stretcher which can be used as a life raft.

2. Description of Background Art

A life raft of this type is known from European patent 1 641 670, which describes a life raft with an inflatable rim which is formed around a trapezium-shaped bottom. The inflatable rim extends on the wide front side of the raft and on the sides of the raft which run obliquely to the more narrow rear side of the raft. A person who has fallen into the water can be helped onto the raft by first pushing said person's feet through the opening at the rear side onto the raft and then positioning his legs across the wide front side of the inflatable rim. In this case, a helper may be positioned on the wide front side of the bottom.

Such a life raft is also known from Canadian patent 2 590 730, which describes a life raft having a floating body which is formed around a support panel. The support panel extends only partially between the first parts of the floating body in order to create an opening between the interconnected upright second parts of the floating body and the support panel via which a person who has fallen into the water can be pulled onto the support panel. In this case, a helper may lean against the upright part of the floating body.

A drawback of these known life rafts is that the person to be saved has to be pulled from the water through the opening between the support panel and floating body and onto the horizontal support panel. This requires a large amount of effort, in particular with persons who are dressed.

### SUMMARY OF THE INVENTION

It is an object of the invention to provide a life raft by means of which a person who has fallen into the water can be saved with a relatively small expenditure of effort.

According to the invention, a stretcher is provided which is usable as a life raft, comprising an elongate support panel with one or more floating bodies which are operational in the active state, wherein the one or more floating bodies extend on opposite sides of the support panel, wherein the one or more floating bodies have at each of said sides have a first part which is attached to the support panel in its longitudinal direction and a second part on at least one of the ends of the first part, each of which second parts encloses an obtuse angle with the respective first part, and wherein the elongate support panel extends at least to a position between the second parts on either side of the support panel.

The invention is aimed at providing a life raft by means of which a person who has fallen into the water can be saved with relatively little effort.

In an embodiment, one of the ends of the support panel extends at least to a position next to the second part of the floating body.

Consequently, by pushing down the part of the support panel which extends next to the second part of the floating body, the life raft can be brought from a first, stable position, in which the first part of each floating body acts as a float and the support panel is substantially horizontal, to a second position, in which the second part of each floating body acts as a float and the support panel assumes a slanting position in order to make it easier to help a person up onto it. In its second position, the support panel extends into the water and a rescuer can pull a person onto the support panel while partly under water. Due to the upward pressure, this will be effected relatively easily.

Only by then moving the centre of gravity of the person in the direction of the life raft will the raft tilt back into its stable first position.

The life raft known from the abovementioned Canadian patent application is not intended to be tilted, since this would then close off the opening between the support panel and the upright part of the floating body, thus rendering the life raft ineffective.

By providing the end of the support panel which extends between the second parts of the floating body with two footrests on its support side, a rescuer who is standing on the footrests with the support panel being in the second position can grab a person who has fallen into the water under his armpits, pull him out of the water and tilt the life raft into its stable first position by leaning backwards.

### BRIEF DESCRIPTION OF THE DRAWINGS

The invention will be explained in more detail below by means of an exemplary embodiment illustrated in the figures of a stretcher which can be used as a life raft. At the same time, other features and advantages of the invention will be explained.

FIG. 1 shows a perspective view of a stretcher used as a life raft in its basic position;

FIG. 2 shows a side view of the life raft illustrated in FIG. 1 in the water;

FIG. 3 shows a front view of the life raft illustrated in FIG. 1;

FIG. 4 shows a cross section along line A-A in FIG. 3;

FIG. 5 shows the life raft illustrated in FIG. 1 in a tilted position during the rescue of a person who has fallen into the water;

FIG. 6 shows the life raft illustrated in FIG. 1 in its basic position with a saved person;

FIG. 7 shows the life raft illustrated in FIG. 1 provided with a hoisting device for hoisting the life raft out of the water; and

FIG. 8 shows the life raft illustrated in FIG. 1 converted to a stretcher for use on ice.

### DETAILED DESCRIPTION OF THE PREFERRED EMBODIMENTS

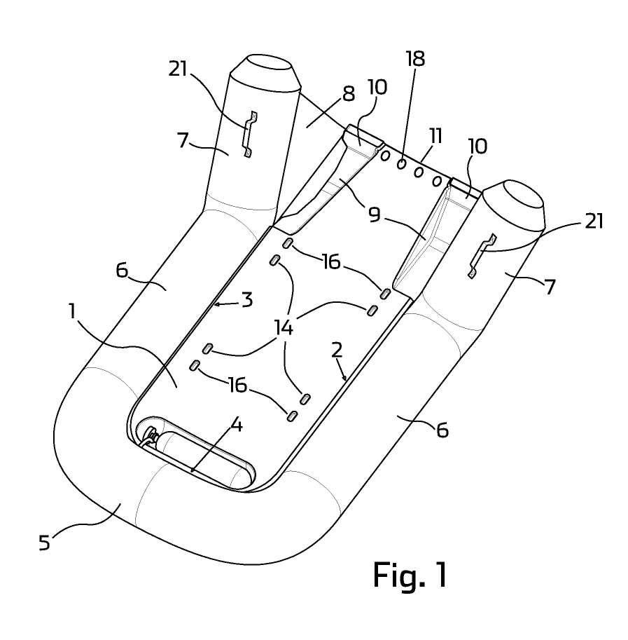

The life raft shown in perspective view in FIG. 1 comprises a support panel 1 which has a length of approximately 0.8-2 m and a width of 0.4-1 m. One embodiment has a length, for example, of 1.8-2 m and a width of approximately 0.75 m.

The dimensions of the support panel 1 are determined by the body size of the persons to be saved which have to fit onto the support panel 1 when they are lying down.

On opposite sides 2 and 3 and at an end 4 on the support panel 1, a U-shaped inflatable tube 5 is attached which is shown in FIG. 1 in the inflated state. As can be seen in FIG. 1, the inflatable tube 5 is only attached to the support panel 1 along approximately a two-third part of its length. This part of the inflatable tube 5 is denoted by reference numeral 6. A part 7 forming part of the inflatable tube 5 and adjoining this part 6 of the inflatable tube 5 forms an obtuse angle α of 130-140° with part 6 of the inflatable tube 5. On the supporting side of the support panel 1, this part 7 of the inflatable tube 5 forms an acute angle with the one-third part of the support panel 1 which is not directly attached to part 6 of the inflatable tube 5. Parts 7 of the inflatable tube 5 are each attached to said one-third part of the support panel 1 by means of a triangular flap 8. In the illustrated embodiment, parts 6 and 7 are shown as adjoining parts which are formed as a single part. Parts 6 and 7 can also be formed as separate floating bodies which do not necessarily have to adjoin one another directly, but obviously do have to make an obtuse angle with one another.

The floating body may also comprise several separate compartments, with, for example, the first part being formed by a first compartment and the second part by a second compartment. The compartments may be joined together, but may also be provided as separate components.

The support panel may be a stiff component, but may also be an inflatable component. In the latter case, it is possible to fold the life raft into a relatively small pack in the non-inflated or inactive state.

Recesses 9 are formed on either side in the support panel 1, near the flaps 8, for forming a footrest 10 in each recess 9 near the end 11 of the support panel 1. The support surface of these footrests 10 is substantially at right angles to the plane in which the upright second parts 7 of the inflatable tube 5 are situated.

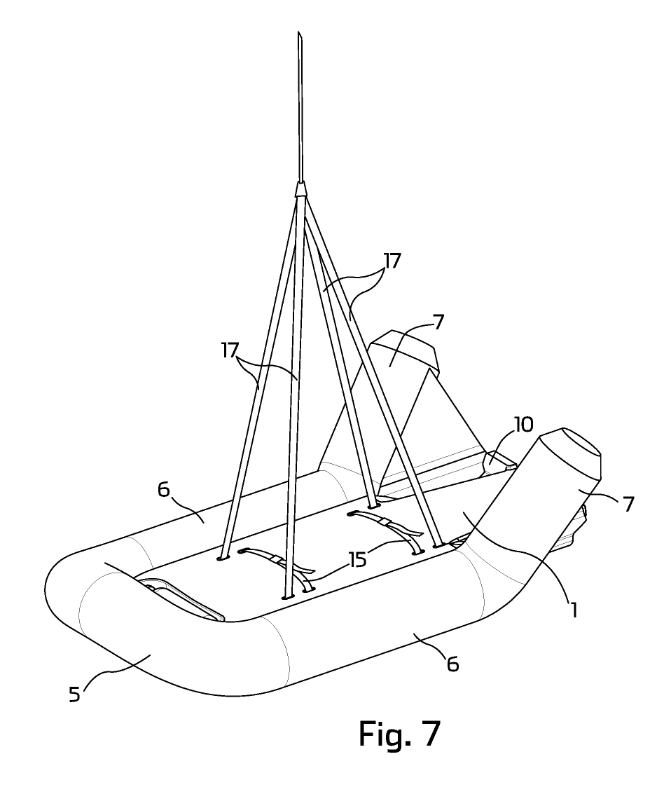

On the support side, the support panel 1 is furthermore provided with a hollowing 12 on its rim 4 for accommodating a compressed air cylinder 13 for inflating the inflatable tube 5. Openings 14 are provided in the centre of the support panel 1 for attaching straps 15 by means of which a rescued person can be secured to the support panel 1, as is indicated in FIG. 7. Further openings 16 are provided in the support panel 1 for attaching hoisting straps 17 for hoisting the life raft with the rescued person thereon out of the water, as is likewise shown in FIG. 7. Near the free end 11 of the support panel 1, a number of holes 18 are provided to allow water to pass through, as will be explained below.

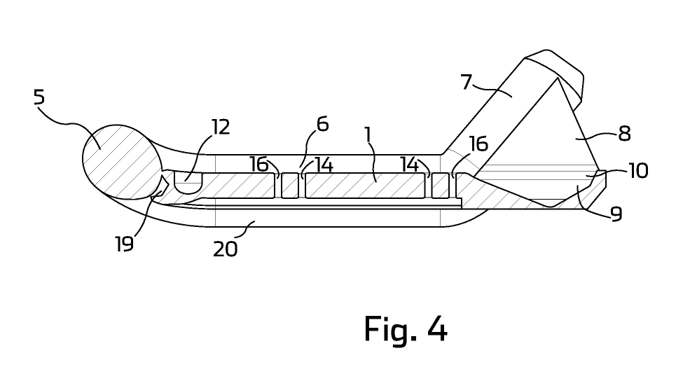

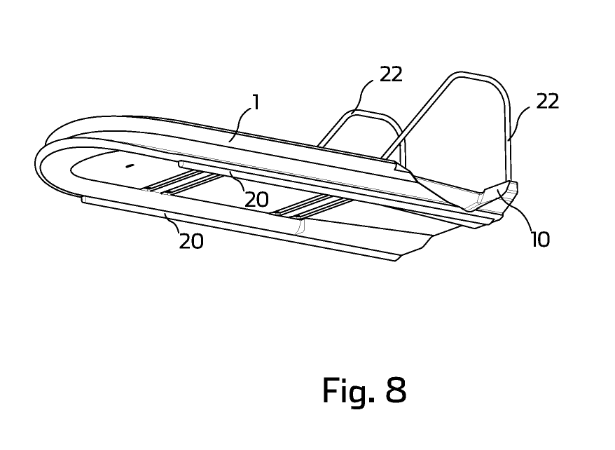

As can be seen in more detail in the cross-sectional drawing according to FIG. 4, a hollowing 19 is provided along the lateral edge of the support panel 1 for stowing away the inflatable tube 5 in the deaerated state. Furthermore, FIG. 4 shows that two sliding blades 20 are provided on the bottom side of the support panel for use of the life raft as a stretcher when rescuing persons on ice, as will be explained below with reference to FIG. 8.

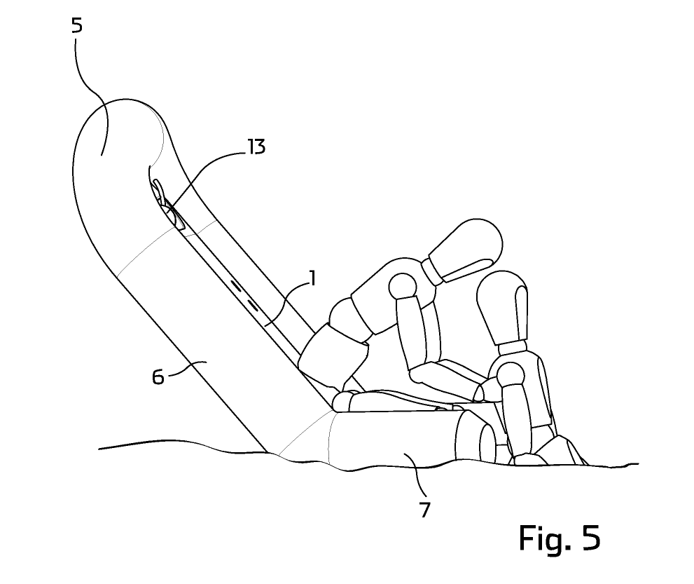

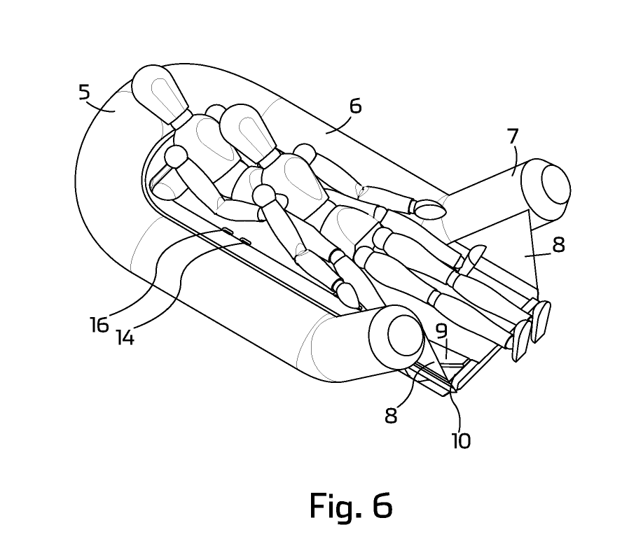

Handles 21 are attached to the top side of the upright second parts 7 of the inflatable tube 5. They serve as an aid for a rescuer when he is getting into the life raft while rescuing a person who has fallen into the water, as will be explained with reference to FIGS. 5 and 6 in the following description of the operation of the life raft.

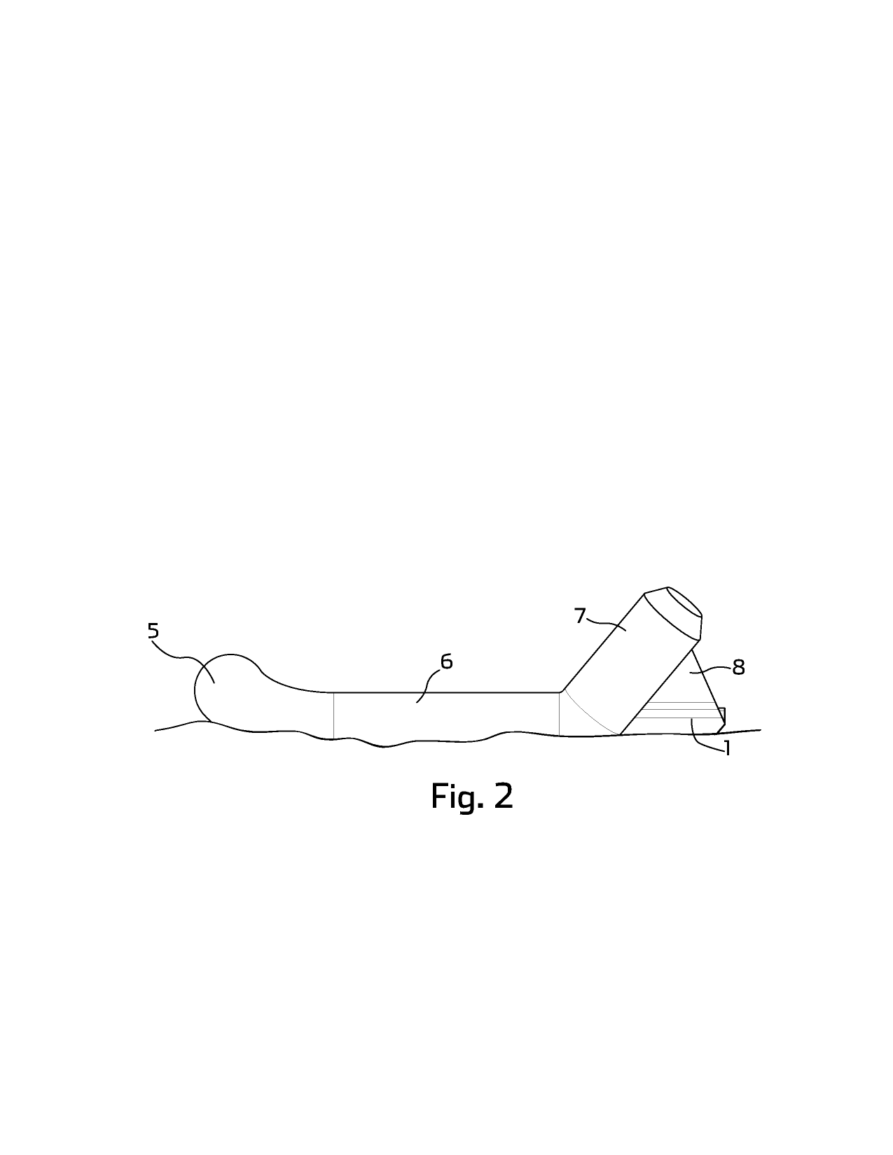

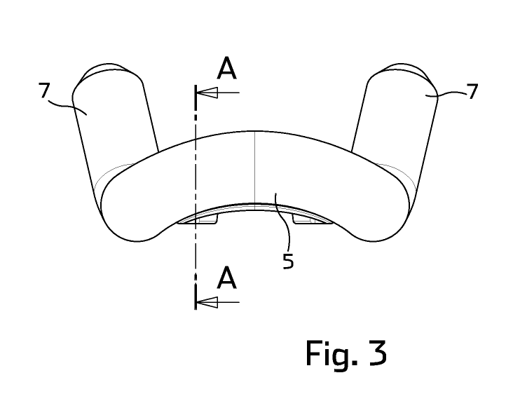

FIG. 5 shows the life raft in a position in which the second parts 7 of the inflated inflatable tube 5 act as floats. This position is reached when a rescuer pulls himself onto the life raft by the handles 21 and stands on the footrests 10. As a result thereof, the life raft will tilt from the unloaded position which is illustrated in FIG. 2 and in which the first parts 6 of the inflated tube 5 act as floats. The latter is the result of the centre of gravity of the unloaded life raft being situated on the side of part 6 at the transition between part 6 and part 7. If a person subjects part 7 to a load by standing on the footrests 10, the life raft tilts about the transition between parts 6 and 7 (the tilting point) and ends up in the position illustrated in FIG. 5. If a rescuer stands on the footrests with his back to the support panel 1, he can grab a person who has fallen into the water below his armpits and pull him up. Due to the fact that both persons are in this case partly under water, it will be possible for the rescuer to pull both himself and the person to be saved into the raft with relatively little expenditure of effort due to the upward pressure. If the rescuer then leans backwards with the person who has been partly pulled out of the water, the centre of gravity of the loaded life raft will move in the direction of part 6 of the inflated tube 5. When this centre of gravity passes the transition between parts 7 and 6, the life raft will tilt to the position illustrated in FIG. 6 and the person to be saved can be readily pulled onto the support panel 1 in its entirety. Pulling the person to be saved onto the life raft is easy partly because the rescuer can pull a person to be saved up between his spread legs. This is also facilitated by deflecting the parts 7 of the inflatable tube 5 slightly outwards, as can be seen in FIG. 3. Due to the water-permeable holes 18 at the end of the support panel 1, water will flow through these holes when the support panel tilts, as a result of which there is less water resistance during tilting and this movement is brought about in a more effective way.

The second parts 7 of the floating body form free ends of the floating body, so that a space is created between the second parts 7 which makes it possible to pull a person to be saved onto the support panel.

Following the rescue, the life raft can be moved in the water by means of a rope (not illustrated) which is attached to the life raft.

It will be clear that the position of the tilting point partly depends on the distribution of weight on either side of the tilting point and the required buoyancy of the life raft in the tilted position illustrated in FIG. 5.

FIG. 7 shows the life raft with the hoisting straps 17 attached thereto for hoisting the life raft together with a rescued person secured thereon out of the water. This may be particularly useful when the transition between the water and the quay is formed by a quay wall.

FIG. 8 shows the life raft as a stretcher for use as a stretcher for a person who has got into difficulties on the ice. In this case, the deaerated inflatable tube 5 is stowed away in the hollowing 19 shown in FIG. 4 and push handles 22 are attached to the support panel 1. When used as a stretcher to rescue people in ice, the life raft has a floating power of, for example, 80 kg so that it can also be used near a hole in the ice. In this case, the stretcher can, for example, be pulled to the bank by means of an attached rope.

When travelling across ice over large distances, the push handles 22 will preferably be used in order to push the stretcher over the ice on its blades 20.

It will be clear that other embodiments are possible without departing from the scope of the invention.

Thus, the support panel 1 may, for example, extend only between the parts 6 and be provided with an upright part at its end which acts as a seat. When a person sits down on the latter, the life raft tilts to a position in which parts 7 of the life raft act as floats. As a result of the seated person or persons (for example a rescuer and a person to be saved) leaning backwards, the life raft tilts to its position in which parts 6 act as floats.

The invention can also be described by means of the following clauses:

Stretcher usable as a life raft, comprising an elongate support panel (1) with at least one floating body (6,7) which is operational in the active state, characterized in that each floating body has a first part (6) which is attached to the support panel (1) along its entire length, and has a second part (7) on at least one of the ends of the first part (6), which second part (7) encloses an obtuse angle (α) with the aforementioned first part (6).
Stretcher, wherein the floating body with said first and second part (6,7) extends on opposite sides (2 and 3) of the support panel (1).
Stretcher, wherein the obtuse angle (a) between the first part (6) and the second part (7) of each floating body (6,7) is between 130 and 140°.
Stretcher, wherein one of the ends (11) of the support panel (1) extends to a position between opposite second parts (7) of the floating bodies (6,7).
Stretcher, wherein the ratio between the length of the first part (6) of each floating body (6,7) and the total length of the floating body (6,7) is between 0.6 and 0.7.
Stretcher, wherein the end (11) of the support panel (1) which extends between the second parts (7) of the floating body (6,7) is provided with at least one footrest (10) on its support side.
Stretcher, wherein each footrest (10) is formed in a hollowing (9) on the support side of the support panel (1).
Stretcher, wherein the end (11) of the support panel (1) which extends between the second parts (7) of the floating body is provided with at least one water-permeable opening (18).
Stretcher, wherein a flexible flap (8) is provided between each second part (7) of the floating body and a longitudinal side of the support panel (1).
Stretcher, wherein at least one second part (7) of a floating body (6,7) has a handle (21) on its upper side.
Stretcher, wherein the floating body (6,7) has a third part which connects the first parts (6) of the floating bodies to one another along the other end (4) of the support panel (1) in order to form one continuous floating body (5).
Stretcher wherein the floating bodies forming a single part consist of an air-inflatable tube (5).
Stretcher wherein support panel (1) has a continuous hollowing (19) on its periphery for stowing away the inflatable tube (5;6,7) in its non-active state.
Stretcher wherein the support panel (1), on said other end (4), has a provision (12) for accommodating a compressed air cylinder (13) for inflating the inflatable tube (5).
Stretcher wherein the support panel (1) is provided with fixable straps (15) in order to secure a person on the stretcher.
Stretcher wherein the stretcher has a provision on its front side and/or rear side for pulling the stretcher by an attachable line.
Stretcher wherein the stretcher is provided with hoisting means (17) for lifting or hoisting the stretcher.
Stretcher wherein a motor drive can be coupled thereto in order to move the raft without manual power when it is being used as a life raft.
Stretcher wherein the support panel (1) is provided with sliding blades (20) on its underside for moving the stretcher across the ice when rescuing persons on or near the ice.
Stretcher wherein the upper side of the support panel is provided with detachable push handles (22) for moving the stretcher across ice.

1. Stretcher usable as a life raft, comprising an elongate support panel with one or more floating bodies which are operational in the active state, wherein the one or more floating bodies extend on opposite sides of the support panel, wherein the one or more floating bodies have at each of said sides have a first part which is attached to the support panel in its longitudinal direction and a second part on at least one of the ends of the first part, each of which second parts encloses an obtuse angle with the respective first part, and wherein the elongate support panel extends at least to a position between the second parts on either side of the support panel.

2. Stretcher as claimed in claim 1, wherein the second part, on the side facing away from the first part, forms a free end of the one or more floating bodies.

3. Stretcher as claimed in claim 1, wherein one of the ends of the support panel extends at least to a position next to the second part of the one or more floating bodies.

4. Stretcher as claimed in claim 1, wherein the end of the support panel which extends to a position next to the second part of the floating body is provided, on its support side, with at least one footrest,

5. Stretcher as claimed in claim 4, wherein each footrest is formed in a hollowing on the support side of the support panel.

6. Stretcher as claimed in claim 1, wherein the ratio between the length of the first part and the total length of the respective floating body is between 0.6 and 0.7.

7. Stretcher as claimed in claim 1, wherein the obtuse angle between the first part and the second part is between 130° and 140°.

8. Stretcher as claimed in claim 1, wherein the end of the support panel which extends between the second parts of the one or more floating bodies is provided with at least one water-permeable opening.

9. Stretcher as claimed in claim 1, wherein a flexible flap is provided between each second part of one or more floating bodies and a longitudinal side of the support panel.

10. Stretcher as claimed in claim 1, wherein the stretcher comprises a floating body, and wherein the floating body has a third part which connects the first parts of the floating bodies to one another along the other end of the support panel in order to form one continuous floating body,

11. Stretcher as claimed in claim 10, wherein the floating body forming a single part comprises an air-inflatable tube.

12. Stretcher as claimed in claim 10, wherein the support panel has a continuous hollowing on its periphery for stowing away the inflatable tube in its non-active state.

13. Stretcher as claimed in claim 10, wherein the support panel has a hollowing on said other end for accommodating a compressed air cylinder for inflating inflatable tube.

14. Stretcher as claimed in claim 1, wherein the support panel is provided with sliding blades on its underside for moving the stretcher across the ice when rescuing persons on or near the ice and/or the support panel is provided with detachable push handles on its upper side for moving the stretcher across ice.

15. Stretcher usable as a life raft, comprising an elongate support panel with one or more floating bodies which are operational in the active state, wherein the one or more floating bodies have a first part which is attached to the support panel in its longitudinal direction and a second part on at least one of the ends of the first part, which second part encloses an obtuse angle with the first part.
